(19) United States
(12) Patent Application Publication
(10) Pub. No.: US 2019/0118632 A1
(43) Pub. Date: Apr. 25, 2019

(54) VEHICLE AND POWERTRAIN COMPONENT MOUNTING SYSTEM

(71) Applicant: FORD GLOBAL TECHNOLOGIES, LLC, Dearborn, MI (US)

(72) Inventor: Henrique Teixeira AVILA, Tatui (BR)

(21) Appl. No.: 15/790,621

(22) Filed: Oct. 23, 2017

(51) Int. Cl. B60K 5/12; B62D 25/08

(52) U.S. Cl. CPC B60K 5/12; B62D 25/082

(57) ABSTRACT

A vehicle includes a body, a T-nut, and a mounting bracket. The body has a side rail that partially defines an engine compartment and defines a T-slot. The T-nut is disposed and slidable within the T-slot. The mounting bracket has a proximal end secured to the side rail by a fastener that extends into the T-slot and engages the T-nut and a distal end that extends from the proximal end into the engine compartment.

### TECHNICAL FIELD

The present disclosure relates to vehicles and systems for mounting vehicle components to the vehicle body or frame.

### BACKGROUND

Vehicles include structural components such as bodies or frames that provide support for other vehicle components.

### SUMMARY

A vehicle includes a body, a T-nut, and a mounting bracket. The body has a side rail that partially defines an engine compartment and defines a T-slot. The T-nut is disposed and slidable within the T-slot. The mounting bracket has a proximal end secured to the side rail by a fastener that extends into the T-slot and engages the T-nut and a distal end that extends from the proximal end into the engine compartment.

A vehicle body includes a first rail, a second rail, T-nuts, a first powertrain bracket, and a second powertrain bracket. The first and second rails are disposed on opposing sides of an engine compartment. The first and second rails also define longitudinally extending T-slots. The T-nuts are disposed and slidable longitudinally within each T-slot. The first and second powertrain mounting brackets are secured to the first and second rails, respectively, within the engine compartment via fasteners that extend into the T-slots and engage the T-nuts.

An engine anchoring system includes a vehicle body, a T-nut, and a mounting bracket. The vehicle body has a side rail that defines a T-slot. The T-nut is disposed and slidable within the T-slot. The mounting bracket is configured to secure an engine to the side rail. The mounting bracket is secured to the side rail by a fastener that extends into the T-slot and engages the T-nut.

### BRIEF DESCRIPTION OF THE DRAWINGS

FIG. 1 is a perspective view of a portion of a vehicle including a mounting configuration for the powertrain components of the vehicle;

FIG. 2 is a perspective exploded view of a powertrain component mounting bracket and a side rail of a vehicle body;

FIG. 3 is a perspective view of the side rail of the vehicle body;

FIG. 4 is a perspective view of a reinforcement component of the side rail of the vehicle body;

FIG. 5 is lower magnified view of a portion of the reinforcement component;

FIG. 6 is a magnified cross-sectional view taken along line 6-6 in FIG. 5; and

FIG. 7 is a magnified cross-sectional view taken along line 7-7 in FIG. 5

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

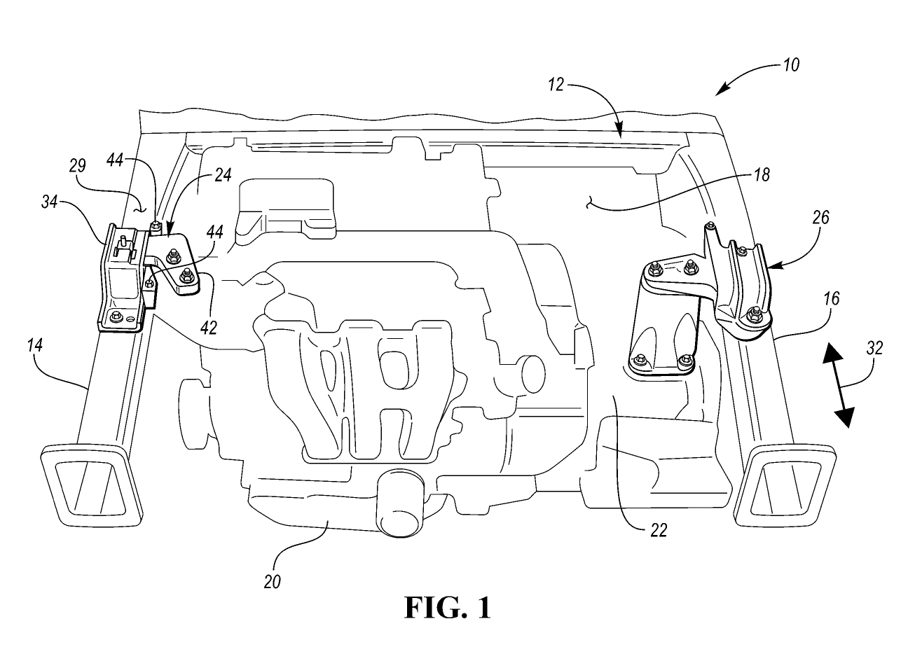

Referring to FIG. 1, a perspective view of a portion of a vehicle 10 including a mounting configuration for the powertrain components of the vehicle 10 is illustrated. The vehicle 10 includes a frame or body structure 12. The body may include various components of the vehicle's body-in-white structure. The body structure 12 may include roof rails, pillars (such as A-pillars, B-pillars, C-pillars, D-pillar, etc.), side rails, front rails, rear rails, rocker panels, strut or shock towers, roof cross members, floor cross members, floor panels, roof panels, firewalls, radiator core supports, powertrain component supports (e.g., engine or transmission supports), or any other component of the vehicle body-in-white structure or the frame known in the art. The body components may be connected to each other a welding process or by fasteners, such as rivets, screws, bolts, or any other type of faster known to a person of ordinary skill in the art.

The body structure 12 includes a first side rail 14 and a second side rail 16. The first side rail 14 and the second side rail 16 define an engine compartment 18 therebetween. One or more powertrain components, such as an engine 20 and a transmission 22 are disposed within the engine compartment 18. The engine 20 and transmission 22 may be secured to each other. The engine 20 and transmission 22 combination may then be secured to the body structure 12. More specifically, the engine 20 and transmission 22 combination may be secured to the first side rail 14 and the second side rail 16, respectively, via a first powertrain mounting bracket 24 and a second powertrain mounting bracket 26, respectively. The first powertrain mounting bracket 24 and the second powertrain mounting bracket 26 may alternatively be referred to as engine mounting brackets or transmission mounting brackets.

The configuration depicted in FIG. 1 is a front wheel drive configuration where the engine 20 and transmission 22 are each disposed within the engine compartment 18. The configuration in FIG. 1, however, in not meant to be limiting and other configurations, such as a rear wheel drive configuration, should be construed as disclosed herein. In a rear wheel drive configuration, the engine 20 may be the only powertrain component that is disposed within the engine compartment 18 and is secured to the first side rail 14 and the second side rail 16 of the body structure 12 via the first mounting bracket 24 and second mounting bracket 26. The mounting configuration for the powertrain components depicted in FIG. 1 may also be referred to a powertrain component anchoring system, an engine anchoring system, and/or a transmission anchoring system.

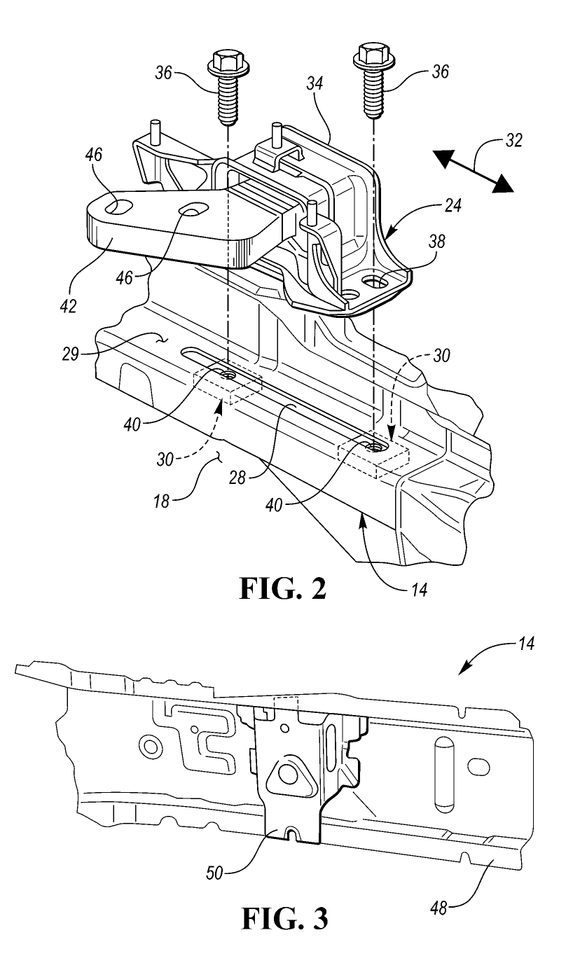

Referring to FIG. 2, a perspective exploded view of the first powertrain mounting bracket 24 and the first side rail 14 of the vehicle body structure 12 is illustrated. It should be understood that although FIG. 2 only depicts the first powertrain mounting bracket 24 and the first side rail 14, FIG. 2 and any description herein may be applicable to the second mounting bracket 26 and the second side rail 16 of the vehicle body structure 12. The first side rail 14 of the vehicle body structure 12 may define a T-slot 28. The T-slot 28 may be defined in the first side rail 14 such that the T-slot 28 is open along and extends downward from an upper surface 29 of the first side rail 14. One or more T-nuts 30 may be disposed within the T-slot 28. The one or more T-nuts 30 may have a cross-sectional shape that is square, rectangular, T-shaped, or any other desirable shape. The one or more T-nuts 30 may be slidable within the T-slot 28. More specifically, the T-slot 28 may extend in a longitudinal direction 32 from a front of the vehicle 10 to a rear of the vehicle 10 (or a front of the first side rail 14 to a rear of the first side rail 14) and the one or more T-nuts 30 may be slidable within the T-slot 28 in the longitudinal direction 32.

The first powertrain mounting bracket 24 has a proximal end 34 that is secured to the first side rail 14 by at least one fastener 36 that extends into the T-slot 28 and engages one or more T-nuts 30. More specifically, the at least one fastener 36 may extend through at least one through hole 38 defined in the first powertrain mounting bracket 24 and engage tapped holes 40 defined in the one or more T-nuts 30 to secure the proximal end 34 of the first powertrain mounting bracket 24 to the first side rail 14. The first powertrain mounting bracket 24 has a distal end 42 that extends from the proximal end 34 and into the engine compartment 18.

Referring now to FIGS. 1 and 2, a powertrain component (e.g., the engine 20) may be secured to the distal end 42 of the first powertrain mounting bracket 24. One or more fasteners 44 may secure the powertrain component to the distal end 42 of the first powertrain mounting bracket 24. More specifically, the One or more fasteners 44 may extend through at least one through hole 46 defined in distal end 42 the first powertrain mounting bracket 24 and engage tapped holes (not shown) defined in the powertrain component to secure powertrain component to the distal end 42 of the first powertrain mounting bracket 24.

An opposing end or side of the powertrain component, or a second powertrain component (e.g., the transmission 22), may be secured to the second powertrain mounting bracket 26. Fasteners may secure the second powertrain mounting bracket 26 to the second side rail 16 of the vehicle body structure 12. The fasteners may extend through a T-slot defined in the second side rail 16 and engage one or more T-nuts disposed within the T-slot defined in the second side rail 16. Additional fasteners may then secure the powertrain component to the second powertrain mounting bracket 26.

Referring to FIG. 3, a perspective view of the first side rail 14 is illustrated. It should be understood that although FIG. 3 only depicts the first side rail 14, FIG. 3 and any description herein may be applicable to the second side rail 16 of the vehicle body structure 12. The first side rail 14 may include an elongated member 48 and a reinforcement bracket or reinforcement component 50. The reinforcement component 50 may be secured an internal surface of the elongated member 48. More specifically, the reinforcement component 50 may be secured the internal surface of the elongated member 48 by a welding process, glue, fasteners, or any other method of securing sheet metal components to each other known by a person of ordinary skill in the art.

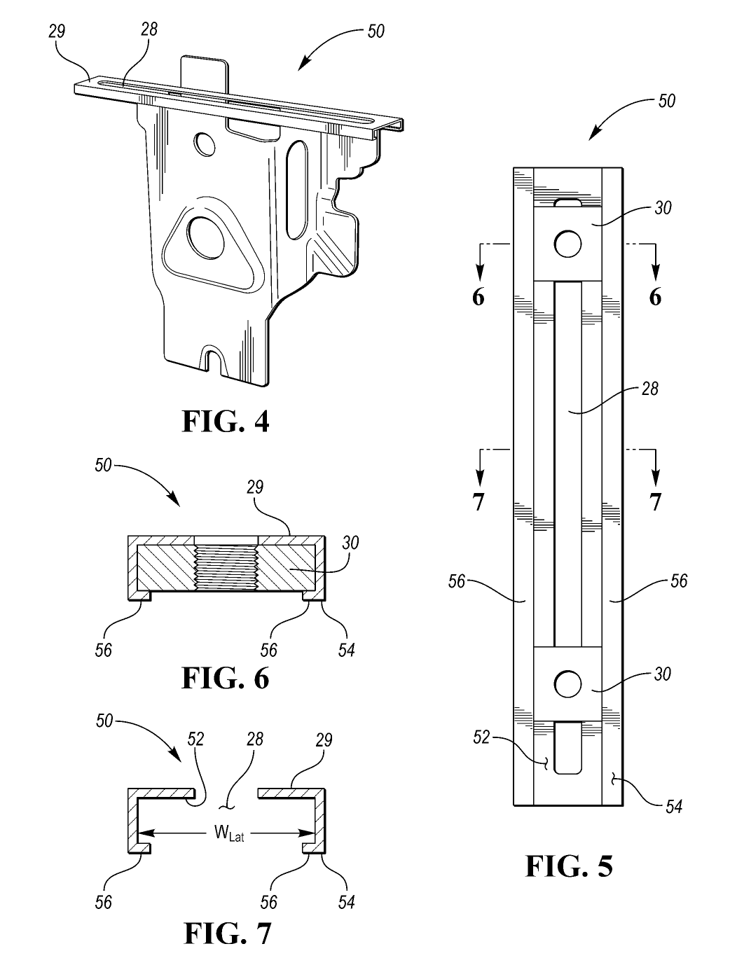

Referring to FIGS. 4-7, the reinforcement component 50, which is a subcomponent of the first side rail 14, is further illustrated. The T-slot 28 defined first side rail 14 (or second side rail 16) of the vehicle body structure 12 may be defined more specifically by the reinforcement component 50. The first side rail 14, or more specifically the reinforcement component 50 of first side rail 14, may include a stepped surface 52 that is disposed below the upper surface 29 of the first side rail 14. The stepped surface 52 may partially define the T-slot 28. A lateral width W_{Lat} of the T-slot 28 is increased extending downward from the stepped surface 52, relative to the lateral width W_{Lat} of the T-slot 28 between the upper surface 29 and the stepped surface 52. The T-slot 28 may be open along a bottom surface 54 of the first side rail 14, or more specifically a bottom surface 54 of the reinforcement component 50 of first side rail 14. The first side rail 14, or more specifically the reinforcement component 50 of first side rail 14, may include one or more overhangs 56 along the bottom surface 54 that partially overlaps the T-slot 28.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle comprising:
a body having a side rail partially defining an engine compartment and defining a T-slot;
a T-nut disposed and slidable within the T-slot; and
a mounting bracket having a proximal end secured to the side rail by a fastener that extends into the T-slot and engages the T-nut and a distal end extending from the proximal end into the engine compartment.

2. The vehicle of claim 1, wherein the T-slot extends in a longitudinal direction from a front to a rear of the vehicle.

3. The vehicle of claim 2, wherein the T-nut is slidable within the T-slot in the longitudinal direction.

4. The vehicle of claim 1, wherein the T-slot is defined in the side rail such that the T-slot is open along and extends downward from an upper surface of the side rail.

5. The vehicle of claim 4, wherein the side rail includes a stepped surface that is disposed below the upper surface and partially defines the T-slot, and wherein a lateral width of the T-slot is increased extending downward from the stepped surface.

6. The vehicle of claim 4, wherein the T-slot is open along a bottom surface of the side rail.

7. The vehicle of claim 6, wherein the side rail includes an overhang along the bottom surface that partially overlaps the T-slot.

8. The vehicle of claim 1 further comprising an engine secured to the distal end of the mounting bracket.

9. A vehicle body comprising:
first and second rails disposed on opposing sides of an engine compartment, the rails defining longitudinally extending T-slots;
T-nuts disposed and slidable longitudinally within each T-slot; and
first and second powertrain mounting brackets secured to the first and second rails, respectively, within the engine compartment via fasteners that extend into the T-slots and engage the T-nuts.

10. The body of claim 9, wherein the T-slots are defined in the side rails such that the T-slots are open along and extend downward from upper surfaces of the side rails.

11. The body of claim 10, wherein the side rails include stepped surfaces that are disposed below the upper surfaces and partially define the T-slots, and wherein lateral widths of the T-slots are increased extending downward from the stepped surfaces.

12. The body of claim 10, wherein the T-slots are open along bottom surfaces of the side rails.

13. The body of claim 12, wherein the side rails include overhangs along the bottom surfaces that partially overlap the T-slots.

14. An engine anchoring system comprising:
a vehicle body having a side rail that defines a T-slot;
a T-nut disposed and slidable within the T-slot; and
a mounting bracket, that is configured to secure an engine to the side rail, secured to the side rail by a fastener that extends into the T-slot and engages the T-nut.

15. The system of claim 14, wherein the T-slot extends in a longitudinal direction from a front to a rear of the vehicle body.

16. The system of claim 15, wherein the T-nut is slidable within the T-slot in the longitudinal direction.

17. The system of claim 14, wherein the T-slot is defined in the side rail such that the T-slot is open along and extends downward from an upper surface of the side rail.

18. The system of claim 17, wherein the side rail includes a stepped surface that is disposed below the upper surface and partially defines the T-slot, and wherein a lateral width of the T-slot is increased extending downward from the stepped surface.

19. The system of claim 17, wherein the T-slot is open along a bottom surface of the side rail.

20. The system of claim 19, wherein the side rail includes an overhang along the bottom surface that partially overlaps the T-slot.
